(19) United States
(12) Patent Application Publication
(10) Pub. No.: US 2020/0020930 A1
(43) Pub. Date: Jan. 16, 2020

(54) Thixotropic Nanoparticle Silicon Anodes and Deoxygenated Lithium Metal Oxide Cathodes

(71) Applicant: Mossey Creek Technologies, Inc., Jefferson City, TN (US)

(72) Inventor: John Carberry, Talbott, TN (US)

(73) Assignee: Mossey Creek Technologies, Inc., Jefferson City, TN (US)

(21) Appl. No.: 16/411,818

(22) Filed: May 14, 2019

Related U.S. Application Data
(63) Continuation-in-part of application No. PCT/US2017/062458, filed on Nov. 20, 2017.
(60) Provisional application No. 62/423,968, filed on Nov. 18, 2016.

(51) Int. Cl. H01M 4/1395; H01M 4/62; H01M 10/0525; H01M 4/38

(52) U.S. Cl. CPC H01M 4/1395; H01M 4/622; H01M 2004/027; H01M 4/386; H01M 4/625; H01M 10/0525

(57) ABSTRACT

Anodes formed from a thixotropic mixture including spherical silicon nanospheres, a dispersant-binder, an alcoholic carrier liquid, and conductive carbon are disclosed. Cathodes formed from a thixotropic mixture including lithium metal oxide particulates, a dispersant-binder, an alcoholic carrier liquid, and conductive carbon also are disclosed. The thixotropic mixtures are applied to a metal conductor foil or combined with metal conductor particulates and cured to form the electrode. After curing, the electrode includes the metal conductor and the solids held in a crosslinked polymer matrix formed by the dispersant-binder on the surface of the metal conductor as a thin film. Anodes are preferably formed from a copper metal conductor, while cathodes are preferably formed from an aluminum metal conductor. The electrodes formed from the thixotropic mixture may offer an up to 1,200% improvement in energy transfer in relation to conventional carbon-based anodes.

### REFERENCE TO RELATED APPLICATIONS

This application is a continuation-in-part of International Application No. PCT/US17/62458 entitled “Thixotropic Nanoparticle Silicon Anodes and Deoxygenated Lithium Metal Oxide Cathodes” filed Nov. 20, 2017, which claims the benefit of U.S. Provisional Application No. 62/423,968 entitled “Thixotropic Nanoparticle Silicon Anodes and Deoxygenated Lithium Metal Oxide Cathodes” filed Nov. 18, 2016, both of which are incorporated by reference in the entirety.

### BACKGROUND

Lithium ion batteries include at least two electrodes, with one electrode being an anode and another electrode being a cathode when the battery is placed across a load. Present anodes and cathodes are typically constructed by depositing an electrically conductive slurry to form a thin film on a metallic foil. The anode typically uses a copper foil and the cathode an aluminum foil. The deposition slurry generally includes a binder, an active component (graphite is typically used for the anode and a metal oxide for the cathode), a conductive constituent, often carbon black, and other chemicals to buffer the slurry to the desired pH.

The anode of a lithium ion battery undergoes extensive expansion and contraction during the lithiation/delithiation cycles resulting from charging and discharging the battery, respectively. During the lithiation or delithiation process, a positive or negative volume change takes place when lithium enters or leaves the thin film deposited on the metallic foil, which together form the anode.

Physical constraints to expansion and contraction are imposed on the anode by the bond between the surface of the metal foil on which the thin film resides and the thin film. Regardless of these physical constraints, lithium atoms, in the form of positively charged ions, heterogeneously distribute into and throughout the thin film during charging. This heterogeneous distribution causes substantial and uneven expansion in the physical dimensions of the thin film. During delithiation, this process reverses and results in similarly uneven contraction in the physical dimensions of the thin film.

The repetitive and uneven expansion and contraction of the thin film initially leads to cracking within the thin film. With continued use, the cracks within the thin film propagate to the bond between the thin film and the surface of the metallic foil, which causes a separation of the thin from the surface of the metallic foil. This physical separation results in a significant reduction in electrical conductivity between the electrochemically active thin film and the metal conductor of the anode.

Various materials have different capacities to adsorb ions and hence have different rates of corresponding lithiation expansion. For instance, graphite's ion adsorption capacity is limited to approximately 380 mAh/gram, while silicon's ion adsorption capacity is more than an order of magnitude greater at about 4200 mAh/gram. Therefore, when fully “lithiated”, thus charged, silicon can theoretically expand about 400% by volume. In actual use, graphite expands about 4% by volume during charging, while silicon expands about 280% by volume.

Physical breakage from repeated lithiation and delithiation is a key factor limiting the conventional carbon-based thin film anodes in commercial lithium ion batteries to approximately 700 cycles of full-depth charging. Thus, to increase the number of charge cycles available for the battery, full-depth charging is often avoided by preventing full-depth discharge; however, the imposed discharge limit reduces the current available from the battery. Carbon-based thin film anodes also limit the current transfer of lithium ion batteries due to the upper theoretical current transfer limit of approximately 380 mAh/g for the carbon-based thin film—thus necessitating the use of many small batteries to provide high current output.

The disadvantages of physical breakage and limited current carrying capacity for conventional carbon-based thin film anodes are most prevalent for high load and use applications, including industrial electrical equipment, electric vehicles, and high-performance computing environments. Thus, it would be desirable to replace carbon with a material that does not break after repeated charge/discharge cycles, while simultaneously providing a higher current transfer ability to the thin film anode, and thus, to the battery.

Conventional carbon-based anodes are generally made from copper foil coated with an aqueous slurry of approximately 92% graphite, 4-5% of a binder, such as polyacrylic acid or polyvinylidene fluoride, 2-4% carbon black as a conductor, lithium hydroxide, and sodium hydroxide. Conventional carbon-based anodes including graphite have a layered, planar structure at the molecular level. The individual graphite layers include graphene where the carbon atoms are arranged in a honeycomb lattice in the X-Y plane with a separation of about 0.14 nm. In this X-Y plane the carbon atoms are covalently bonded and are electrically conductive through the X-Y plane, as three of carbon's four bonding sites participate in the X-Y plane, while the fourth bonding site of the Z-axis remains open.

In contrast to the X-Y planes, in the Z-axis, the carbon atoms are held by weak van der Walls interaction and are separated by approximately 0.33 nm, more than twice the distance of the honeycomb X-Y plane lattice. This enhanced distance between the lattice layers in the Z-axis allows the lattice layers in the X-Y planes to slide past each other and to separate in the Z-axis. This ability of the X-Y planes to separate in the Z-axis is believed to allow for lithium to enter between the X-Y planes of the honeycomb lattice. However, as lithiation and delithiation continually occur during charging and discharging of the battery, more and more of the X-Y planes separate to the point where they remain separated, thus losing electrical conductivity through the Z-axis of the material.

Silicon (Si) may be considered as a potential replacement for graphite in thin film anode formation due to a theoretical current transfer limit of approximately 4,200 mAh/g. The 4,200 mAh/g theoretical current transfer limit of silicon is an order of magnitude greater than the theoretical current transfer limit of carbon, 380 mAh/g. The significantly enhanced theoretical current transfer limit of silicon in relation to carbon is believed to attributable to the ability of silicon metal to form the Li₂₁Si₅ alloy; thus providing significantly greater lithiation per molecule in relation to the LiC₆ alloy of carbon. Thus, for the silicon alloy greater than five lithium atoms may be present for each silicon atom, while for the carbon alloy six carbon atoms are required for a single lithium atom.

While silicon may theoretically overcome the current carrying limitation of carbon, conventional silicon thin film anodes experience a more rapid conductivity loss than carbon thin film anodes from a charge/discharge (lithiation) breakage perspective. This conductivity loss is believed to arise because the silicon in contact with the metallic foil of the anode cannot repeatedly undergo volume expansion and contraction while remaining attached to the surface of the foil. When lithiated, crystalline silicon sustains an approximately 400% volume increase, which is significantly greater than that experienced by carbon—as would be expected in view of the much greater theoretical current transfer limit of silicon. Thus, the silicon particles forming the thin film surface of the anode increase to nearly four times their original volume when charged, then shrink to a volume approximating their original volume when discharged, and then again increase to nearly four times their original volume when recharged. This repeated expansion and contraction of the silicon particles is believed to break the silicon particles away from the metallic foil—thus reducing electrical conductivity.

Conventional carbon-based anodes are generally paired with lithium metal oxide-based cathodes and an electrolyte system to form a battery. Lithium metal oxide-based cathodes are generally formed from aluminum foil coated with an aqueous slurry of approximately 90% lithium cobalt oxide, 5% acetylene black as a conductor, and a few to several thousand percent of a binder, such as polyvinylidene fluoride.

FIG. 1 represents a lithium ion battery 100 undergoing a discharge cycle where electrons are flowing from lithium atoms interned within the anode film through the metallic foil of the anode and to the metallic foil of the cathode. The electron flow (current) from the negatively charged anode to the positively charged cathode may be measured as amperage at the meter 120. As electrons are lost from the anode, the interned lithium atoms become ionized lithium cations, migrate from the thin film on the surface of the metallic foil of the anode into the electrolyte, travel through the electrolyte, and then enter the metal oxide (MOx) thin film on the surface of the metallic foil of the cathode.

The metallic foil forming the anode and the cathode may be formed from a solid metal, a combination of solid metals, or metal plated or deposited on a suitable substrate. A solid metal foil, typically from 10 to 25 microns, may be used to form each electrode, with a thin film held together and onto the metallic foil by a binder. The binder bonded film on the metal foil used to form the anode and cathode electrodes may be typically from 40 to 100 microns above the top surface of the metallic foil.

Multiple physical forms of silicon have been attempted to prevent conductivity loss at the anode resulting from breakage failure, such as described in WO 2008/139157, filed May 11, 2007, to Green. In general, these approaches have fallen into spheres, films, and fibers.

One attempt involved using spherical silicon particles having diameters in the 1-7 nanometer range with the presumption that the nanoscale particles can more readily undergo the large volumetric expansion/contraction cycles associated with lithium insertion/extraction without breaking. This “tiny is better” approach is believed to have suffered from three deficiencies.

The first deficiency is believed to be the degree of physical separation between the tiny, spherical silicon particles themselves and the degree of physical separation between the tiny, spherical silicon particles and the copper metallized foil forming the anode. The overall low degree of contact between the tiny, spherical silicon particles and the metalized foil is believed to result in inherently low conductivity.

The second deficiency is believed to be the inability of the lithium to efficiently leave the anode during discharge. The tiny spherical silicon particles are believed to permanently intern a relatively large portion of the lithium ions that insert themselves into the thin film of the anode during charging. Thus, the permanently interned lithium cannot exit the thin film and return to the electrolyte during discharge. Such permanent internment of the lithium within the thin film of the anode is stated to impart a large, and irreversible “capacity” into the lithium ion battery, thus significantly reducing the useful discharge capacity of the battery.

The third deficiency is believed to involve a relatively large contact resistance arising from the tiny, spherical silicon particles. The tiny, spherical silicon particles are believed to create a relatively large number of particle-to-particle contacts for a given mass of silicon. The relatively large number of particle-to-particle contacts is believed to create many points of contact resistance between the tiny particles. The sum of these many points of contact resistance are believed to result in the electrical resistance of the silicon thin film being inherently high.

Attempts at using thin films also are stated to have the disadvantage of when the “thin” film is thick enough to carry the desired current, the “no longer quite so thin” film fractures due to repeated insertion/extraction of the lithium atoms and ions, respectively. Multiple crystalline forms of silicon also are believed to fracture from the repeated insertion/extraction of the lithium atoms and ions, as lithium atom insertion converts the crystalline silicon to an amorphous state and lithium ion extraction reconverts the silicon to a crystalline state.

Attempts at using fibers to mechanically strengthen the morphology of the silicon thin film and thus avoid expansion/contraction breakage arising from the repeated charge/discharge cycles have the disadvantage of the fibers physically distorting due to insertion of the lithium atoms. FIG. 2A shows a silicon fiber as formed, while FIG. 2B and FIG. 2C show a silicon fiber distorted by lithium atom insertion. Though fibers inherently reduce volume expansion along the longitudinal Z-axes, such substantial expansion and contraction in the physical shape of the fibers along the 110 axes (X and Y) may still result in breakage and separation from the metal conductor.

Using fibers to form the silicon thin film on the metallic foil has the added disadvantage that high percentages of fiber in the slurry used to form the thin film undesirably affect the rheology of the slurry during the milling, mixing, and application processes. Thus, in addition to the enhanced cost of forming the fibers, enhanced processing costs and production difficulties may apply in addition to a lower than desirable silicon solid content of the then film deposited on the metallic foil.

As can be seen from the above description, there is an ongoing need for simple and efficient materials and methods for forming improved electrodes for lithium ion batteries, especially in the context of the failure prone anode. There also would be a desire for lithium metal oxide cathodes that do not deactivate the electrolyte or anode of the battery. The materials and methods of the present invention overcome at least one of the disadvantages associated with conventional materials and methods.

### SUMMARY

In one aspect, the invention provides a thixotropic liquid mixture for forming a lithium ion battery anode electrode that includes a solid mixture in an alcoholic carrier liquid. The solid mixture includes spherical silicon nanospheres having an average diameter from 10 to 120 that make up from 20% to 25% of the solid mixture by weight; conductive carbon making up from 60% to 75% of the solid mixture by weight; and a dispersant-binder making up from 3% to 20% of the solid mixture by weight. The thixotropic liquid mixture optionally may include a lithium salt constituting from 1% to 5% of the thixotropic liquid mixture by weight; and a hydroxide buffer constituting from 3% to 5% of the thixotropic liquid mixture by weight.

In another aspect of the invention, there is a method of making a thixotropic mixture for forming a lithium ion battery anode, the method including combining in an attrition mill including a ceramic grinding medium aggregated particles of silicon or lithium cobalt oxide having average diameters in the 3 mm to 5 mm range or larger up to several mm, an alcoholic carrier liquid, an elastic dispersant-binder, conductive carbon, optionally a lithium salt, and optionally a hydroxide buffer; operating the attrition with a paddle speed and duration sufficient to provide spherical nanospheres having an average diameter from 10 to 120 nanometers; isolating the resulting low viscosity liquid from the mill as a thixotropic mixture.

In another aspect of the invention, an anode electrode for a lithium battery is provided, the electrode including a metal conductor and a crosslinked polymer matrix on the metal conductor, the crosslinked polymer matrix including spherical silicon or lithium cobalt oxide nanospheres having an average diameter from 10 to 70 nanometers, a crosslinked elastic dispersant-binder, conductive carbon on the spherical silicon nanospheres, a lithium salt, and a hydroxide buffer.

In another aspect of the invention, a thixotropic mixture for forming a lithium ion battery cathode electrode is provided, the electrode including spherical lithium cobalt oxide nanospheres having an average diameter from 10 to 70 nanometers; a dispersant-binder constituting from 0.25% to 5% of the thixotropic mixture by weight; an alcoholic carrier liquid; and conductive carbon constituting from 1% to 5% of the thixotropic mixture by weight.

In another aspect of the invention, a method of making a thixotropic mixture for forming a lithium ion battery cathode electrode is to provided, the method including combining in an attrition mill including a ceramic grinding medium aggregated particles of lithium cobalt oxide having average diameters in the 3 mm to 5 mm range, an alcoholic carrier liquid, a dispersant-binder, conductive carbon, and a hydroxide buffer; operating the attrition with a paddle speed and duration sufficient to provide spherical lithium cobalt oxide nanospheres having an average diameter from 3 to 70 nanometers; isolating the resulting low viscosity liquid from the mill as a thixotropic mixture.

In another aspect of the invention, a cathode electrode for a lithium battery is provided, the electrode including a metal conductor; and a crosslinked polymer matrix on the metal conductor, the crosslinked polymer matrix including spherical lithium cobalt oxide nanospheres having an average diameter from 3 to 70 nanometers, a crosslinked dispersant-binder, conductive carbon on the spherical lithium cobalt oxide nanospheres, and a hydroxide buffer.

In another aspect of the invention, an anode electrode for a lithium battery is provided, the electrode including a copper foil; and bonded spherical silicon nanospheres having average diameters from 10 to 70 nm on the copper foil, a lithium salt, and a hydroxide buffer.

In another aspect of the invention, an anode electrode for a lithium battery is provided, the electrode including spherical silicon nanospheres having average diameters from 10 to 70 nm bonded on titanium particulates having up to 70% porosity and an average diameter from 5 to 30 micrometers, a crosslinked elastic dispersant-binder adhering the titanium particulates and spherical silicon nanospheres to a separator; and a lithium salt.

The scope of the present invention is defined solely by the appended claims and is not affected by the statements within this summary. Other methods, features, and advantages of the invention will be, or will become, apparent to one of ordinary skill in the art upon examination of the following figures and description.

### DESCRIPTION OF THE FIGURES

In the accompanying figures, the sizes and relative sizes, shapes, and qualities of lines, entities, and regions may be exaggerated for clarity. The components in the figures are not necessarily to scale and are not intended to accurately represent molecules or their interactions, emphasis instead being placed upon illustrating the principles of the invention.

FIG. 1 represents a lithium ion battery undergoing a discharge cycle where electrons are flowing from atomic lithium interned within the anode film through the metal anode and to the metal cathode.

FIG. 2A is an image of a silicon fiber.

FIG. 2B is an image of a lithiation distorted silicon fiber.

FIG. 2C is another image of a lithiation distorted silicon fiber.

FIG. 3A is a representation of an anode formed from a thixotropic mixture on a metal conductor.

FIG. 3B is a representation of an anode formed from a thixotropic mixture on a metal conductor where the conductive carbon particles of FIG. 3A are substituted with conductive carbon nanotubes.

FIG. 4 represents a method of forming a thixotropic mixture suitable for anode formation.

FIG. 5 represents a method of forming a thixotropic mixture suitable for cathode formation.

FIG. 6 is a graph of the charge/discharge performance of a half-cell in relation to anode silicon.

FIG. 7 is a graph of the charge/discharge performance of a half-cell in relation to anode silicon and conductive carbon.

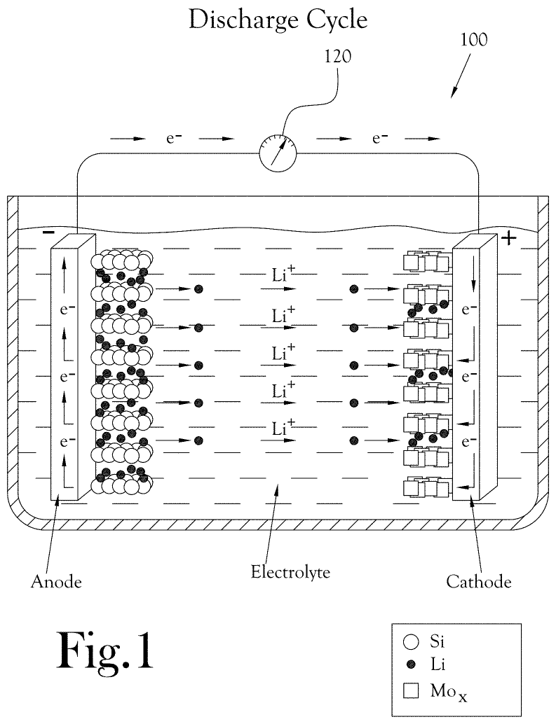

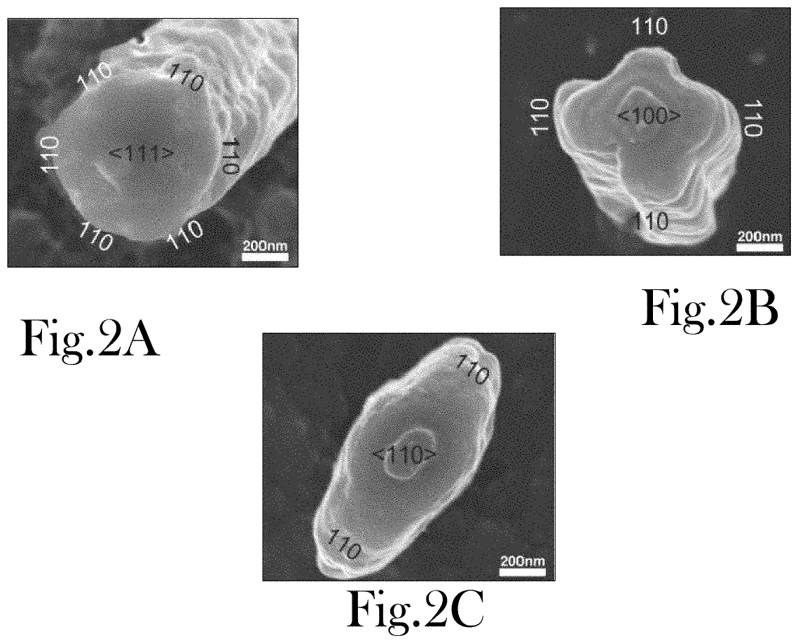

### DETAILED DESCRIPTION

Anodes formed from a thixotropic mixture including spherical silicon nanospheres, a dispersant-binder, an alcoholic carrier liquid, and conductive carbon are disclosed. The thixotropic mixtures may optionally include a lithium salt and/or a buffer. Cathodes formed from a thixotropic mixture including lithium metal oxide particulates, a dispersant-binder, an alcoholic carrier liquid, and conductive carbon also are disclosed. The thixotropic mixtures are applied to a metal conductor foil or combined with metal conductor particulates and cured to form an electrode.

After curing, the electrode includes the metal conductor and the solids held in a crosslinked polymer matrix formed by the dispersant-binder on the surface of the metal conductor as a thin film. Anodes are preferably formed from a copper metal conductor, while cathodes are preferably formed from an aluminum metal conductor. The electrodes formed from the thixotropic mixture may offer an up to 1,200% improvement in energy transfer in relation to conventional carbon-based anodes.

The spherical silicon nanospheres used to form the thixotropic mixtures are substantially spherical in shape, thus lacking significant edges, which can promote breakage of the silicon material during lithiation of the anode. Lithiation is believed to focus with higher “current density” on points, edges, crevices, and other current density concentrating geometries of the silicon, thus creating “lithiation hot spots” that build up an undesirable solid-electrolyte interface (SEI) layer. With repeated charge and discharge cycles of the battery, the SEI layer becomes thicker at the locations with higher current density and forms a barrier to lithiation in relation to the thinner SEI locations where lithiation is less favored. Thus, the differing thicknesses of the SEI layer are believed to result in uneven lithiation of the silicon during charging. The uneven lithiation of the silicon during repeated charge and discharge cycles is believed to break the silicon material forming the anode and to provide a reduced lithiation potential to the anode.

The substantially spherical silicon nanospheres have an average diameter from 10 to 120 nanometers (nm), preferably from 10 to 70 nm, and more preferably from 20 to 30 nm. The silicon used to form the spherical silicon nanospheres is preferably silicon metal of four to eight nines (99.99% to 99.999999%) purity, with eight nines purity preferred, and is largely free of oxygen or silicon oxides (SiₓO_{y}). The silicon used to form the spherical silicon nanospheres may be in the form of agglomerates produced in the fluidized bed process from the decomposition of silane gas (SiH₄) at a temperature range of approximately 400 to 600 degrees Celsius.

Preferable spherical silicon nanospheres have an average diameter large enough to overcome contact resistance, thus approximately 10 nm and greater, while being small enough to not break or fracture during lithiation. Spherical silicon nanospheres having average diameters of less than 120 nm are believed to demonstrate excellent resistance to lithiation breakage. Impurities in the spherical silicon nanospheres not concentrated at the surface also can lead to lithiation breakage as impurities present in the interior of the spheres provide inflection points for breakage.

The formed spherical silicon nanospheres used in the thixotropic mixture have a surface area from approximately 60 to 100 meters per cc, preferably from 70 to 90 meters per cc, and more preferably 75 to 85 meters per cc. Preferably, the spherical silicon nanospheres constitute from 5% to 30% (weight silicon/weight thixotropic mixture) of the thixotropic mixture by weight, more preferably from 10% to 25% of the thixotropic mixture by weight. The mono silane (SiH₄) particulates milled to form the spherical silicon nanospheres may have a D50 of approximately 5 microns prior to milling; however, other pre-milling diameters may be used.

Thus, the spherical silicon nanospheres used to form the present electrodes are not carbon-coated SiOx particles as would be added to a graphite anode to slightly increase the performance of the graphite. Instead, oxygen is excluded to the extent possible during formation of the spherical silicon nanospheres. Preferably the spherical silicon nanospheres include no more than 5% oxygen by weight, preferably no more than 3% oxygen by weight, and more preferably no more than 1.5% oxygen by weight.

The dispersant-binder serves a dual purpose in forming the electrodes. During formation of the thixotropic mixture, the dispersant-binder functions mostly as a dispersant, allowing the mixture to have the desired thixotropic properties. As the dispersant-binder has a greater affinity for the spherical silicon nanospheres than for the alcoholic carrier liquid, the dispersant-binder also is believed to migrate to the surface of the spherical silicon nanospheres during and after milling. The surface coating of the spherical silicon nanospheres by the dispersant-binder during formation of the thixotropic mixture is believed to reduce the formation of silicon oxides and especially hydroxides. Thus, in addition to the alcoholic carrier liquid, the dispersant-binder assists in reducing oxygen contamination of the silicon metal during and after milling. The dispersant-binder preferably constitutes from 0.25% to 5% of the thixotropic mixture by weight, with from 3% to 5% being more preferred (weight of dispersant-binder/weight of the thixotropic mixture).

During formation of the electrode, the dispersant-binder is crosslinked to form the binder for the crosslinked polymer matrix formed on the surface of the metal conductor. The dispersant-binder may be polyvinylidene fluoride (PVDF), polyvinyl butyral (PVB), styrene-butadiene rubber (SBR), carboxymethylcellulose (CMC), polyacrylic acid (PAA), alginate, derivatives thereof, and combinations thereof. However, due to the approximate 280%+volume expansion and contraction during lithiation and delithiation during charge/discharge cycles of the spherical silicon nanospheres, if the crosslinked binder cannot expand and contract at least similarly to and preferably in excess of the nanospheres, the binder will become brittle and break away from the spherical silicon nanospheres. This “binder breakage” will result in an increase in resistance and physical separation of the thin film from the surface of the metal foil of the electrode as previously discussed. The expansion and contraction ability of the crosslinked binder may be referred to as the elasticity of the binder. The PVDF, PVB, SBR, CMC, PAA, and alginate dispersant-binders may be considered non-elastic dispersant-binders.

SEM images of an anode formed with a binder lacking the ability to expand and contract at the 280% level, thus a non-elastic dispersant-binder were obtained. The 40,000 times magnification of the anode surface after formation with the PAA non-elastic dispersant-binder shows many spherical silicon nanospheres with other distinct structures. In contrast, the PAA non-elastic dispersant-binder anode surface after 100 charge/discharge cycles had a substantial loss of nanospheres and other distinct structures. In fact, much of the cycled anode surface had a relatively smooth and continuous surface, which resulted in a substantial decrease in electrical conductivity.

More preferred dispersant-binders have elastomeric limits of at least 300% by volume—thus being elastic dispersant-binders and are otherwise chemically compatible with the chemistry of the electrolyte and other constituents of the thixotropic mixture used to form the electrode. Presently preferred elastic dispersant-binders include polycaprolactone copolyester-type thermoplastic polyurethanes (TPU) such as sold under the tradename PEARLBOND™ DIPP 119 by Lubrizol, polyester-type TPUs such as sold under the tradename PEARLSTICK™ 5703 by Lubrizol, polyether-type TPUs such as sold under the tradename PEARLSTICK™ 57143 by Lubrizol, aromatic polyester type TPUs such as sold under the tradename ESTANE™ E855AB3 by Lubrizol, diblock copolymers of styrene and butadiene such as sold under the tradename KRATON™ D0243B by Kraton, cellulose acetate butyrates such as sold under the tradenames CAB-175, CAB-321, CAB-381, CAB-500, CAB-531, CAB-551, and CAB-553 by Eastman, and ethylene-vinyl acetate copolymers such as sold under the tradename ELVAX™ 40W by DuPont. More preferred are the polyester-type TPUs as sold under the tradename PEARLSTICK™ 5703 by Lubrizol.

The conductive carbon is an electrically conductive form of carbon that essentially may be only carbon or may also include other conductive elements that enhance electrical conductivity. The conductive carbon preferably constitutes from 1% to 5% of the thixotropic mixture by weight. If particulate in nature, the conductive carbon preferably has a relatively large particle size and a relatively high surface area in relation to the spherical silicon nanospheres.

The conductive carbon is believed to assist in lithium insertion and extraction from the spherical silicon nanospheres, but through different pathways. Electromotive forces are believed to drive lithium insertion into the spherical silicon nanospheres during charging of the battery. Electrochemical forces are believed to drive lithium extraction from the spherical silicon nanospheres and into the electrolyte when discharging the battery. For example, if the conductive carbon enhances ion transport, but is less efficient at electrical conduction, the rate at which lithium ions may leave the electrode is enhanced in relation to the rate at which lithium ions may enter the electrode—which reduces the overall current transfer of the battery per unit time. Conversely, if the conductive carbon enhances electrical conductivity, but is less efficient at ion transport, the rate at which lithium ions may leave the electrode is reduced in relation to the rate at which lithium atoms may enter the electrode—which can result in the overheating of the anode. Both the silicon and carbon may lithiate during charging.

Useful forms of conductive carbon include carbon black and carbon nanotubes, with carbon nanotubes being preferred. While carbon black efficiently enhances ion transport, carbon black is believed to lack the electrical conductivity enhancement provided by carbon nanotubes due to inherent contact resistance attributable to the physical structure of carbon black. Thus, carbon nanotubes are presently preferred due to an enhanced electrical conductivity of the nanotubes in relation to carbon black. Other forms of conductive carbon with or without the addition of other conductive elements may be used.

If included in the thixotropic mixture used for anode formation, a lithium salt is believed to start the lithiation process of the anode during formation and thus condition the spherical silicon nanospheres of the anode for enhanced further lithiation during charging cycles. A preferred lithium salt is lithium hydroxide; however, other lithium salts that are electrochemically compatible with the other electrode materials and electrolyte may be used. If included, the lithium salt preferably may constitute from 3% to 5% of the thixotropic mixture by weight and may be added in response to the surface area of the spherical silicon nanospheres.

Ethanol is the preferred alcoholic carrier liquid used during milling to produce the spherical silicon nanospheres and during formation of the thixotropic mixture. However, other alcoholic liquids that scavenge water and/or oxygen and that are compatible with the chemistry of the other thixotropic mixture constituents may be used. The lower boiling point of ethanol in relation to conventional aqueous mixtures provides the added benefit of a quicker drying time during electrode formation and more complete crosslinking of the dispersant-binder, as discussed further below. In ethanol, the spherical silicon nanospheres may constitute from 5 to 8 grams per cubic centimeter (cc) of the thixotropic mixture, preferably from 6 to 8 grams per cc of the thixotropic mixture, and more preferably from 7 to 8 grams per cc of the thixotropic mixture.

When the alcoholic carrier liquid is ethanol, the total solids content by weight of the thixotropic mixture may be from 50% to 80% (weight total solids/weight of thixotropic mixture), preferably from 60% to 80%, and more preferably from 70% to 78%. Solids loading in the alcoholic carrier/dispersant-binder solution is from 30% to 80% (weight solid/weight liquid), with solids loading from 35% to 40% being preferred, and solids loading from 36% to 38% being more preferred. A presently preferred mixture includes from 20 to 25% spherical silicon nanospheres, 60-75% conductive carbon, with the balance of the solids being dispersant-binder by weight.

A buffer may be used to bring the pH of the thixotropic mixture to a neutral, near neutral, or to an alkaline pH. Thus, the amount of buffer used will depend on the amount of dispersant-binder in the mixture with more acidic dispersant-binders, such as PAA requiring more buffer than less acidic dispersant-binders. Preferred buffers are hydroxide buffers, with sodium hydroxide (NaOH) being a more preferred buffer. However, other buffers and hydroxide buffers that are chemically compatible with the other thixotropic mixture constituents may be used.

The buffer is preferably included in the thixotropic mixture at a concentration sufficient to adjust the pH of the thixotropic mixture to a neutral or alkaline range. For example, when ethanol having a pH of 7.3 serves as the alcoholic carrier liquid, little buffer is warranted. The use of an alcoholic carrier liquid as opposed to water as the basis of the described thixotropic mixture provides a stable, near-neutral pH without the need for as much buffer as used in conventional water-based mixtures, as the alcoholic carrier liquids have a more stable pH than water. Preferred pH ranges for the thixotropic mixture are from 6.8 to 7.6 and 7.0 to 7.4, with a pH range of 7.1 to 7.3 being more preferred.

The metal conductor is metal or a metal-based material that provides electrical conductivity (electron transfer) through the battery. For anodes, elemental copper is the preferred metal. For cathodes, elemental aluminum is the preferred metal. The metal conductor may be a solid piece of elemental metal, a layered structure of elemental metal or metals, or an elemental metal plated onto a non-metal substrate. The metal conductors provide for electron transfer from the lithiated spherical silicon nanospheres to the poles of the battery. A preferred thickness of the metal conductor is 10-25 microns, but other thicknesses may be used based on the electrode and battery design.

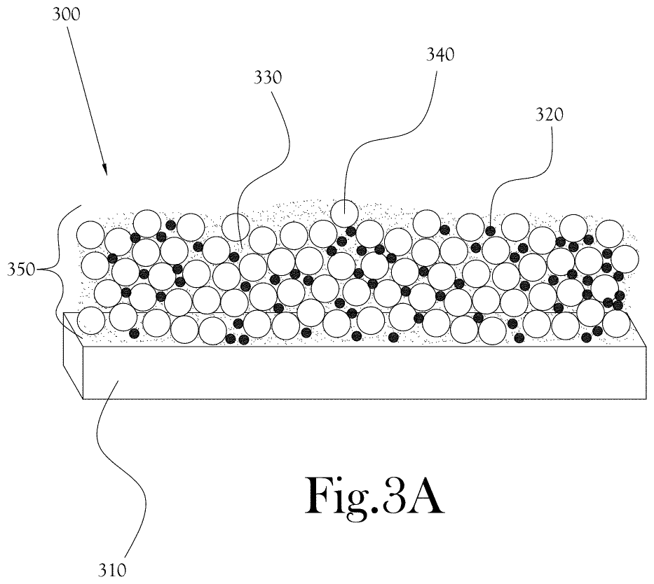

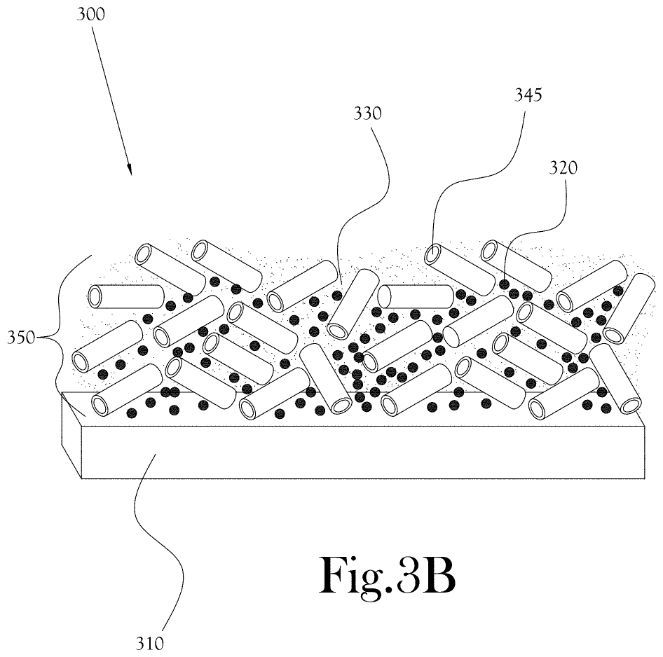

FIG. 3A is a representation of an anode 300 formed from a thixotropic mixture on a metal conductor 310. The spherical silicon nanospheres 320 are held on the surface of the metal conductor 310 and to each other by the crosslinked dispersant-binder 330. The metal conductor 310 may be a metal foil with conductive carbon particles 340 having average diameters of approximately 3 to 4 microns and the smaller spherical silicon nanospheres 320 bonded to the surface of the metal foil providing the metal conductor 310. While the polymer matrix 350 resulting from the crosslinked dispersant-binder 330 holds the conductive carbon particles 340 and spherical silicon nanospheres 320 on the metal foil, the crosslinked dispersant-binder 330 may constitute a relatively small percentage of the polymer matrix 350 forming the thin film on the metal foil. For example, the silicon metal content of the polymer matrix 350 can be from 30% to 90% (silicon weight/polymer matrix weight).

FIG. 3B is a representation of the anode 300 formed from a thixotropic mixture on the metal conductor 310 where the conductive carbon particles 340 are substituted with conductive carbon nanotubes 345.

Alternatively, when a thixotropic mixture is not used, the anode 300 may be formed by pressing spherical silicon nanospheres 320 onto a copper foil serving as the metal conductor 310 and firing at temperatures from 700 to 1,200 degrees Centigrade, preferably from 780 to 860 degrees Centigrade. Spherical silicon nanospheres having an average diameter of approximately 10 nm are preferred in the formation of this anode. This construction provides a silicon bonded structure not relying on the bonding of an organic binder, such as the crosslinked dispersant-binder 330. Instead, bonding occurs between the spherical silicon nanospheres 320 themselves and the copper foil. The porosity of the fired material on the copper foil is preferably about 30%. The copper foil is preferably from 10 to 20 micrometers (um) in thickness, while the bonded spherical silicon nanospheres on the copper foil are preferably from 10 to 50 um in thickness. Either the conductive carbon particles 340 or the conductive carbon nanotubes may be used in this alternate, dispersant-binder free anode.

Alternatively, when a thixotropic mixture is not used, the anode 300 may be formed by adding silicon carbide to the mill during formation of the spherical silicon nanospheres 320. Optionally, graphite/graphene may be added during this process, as may boron. The resulting slurry is pressed onto a copper foil serving as the metal conductor 310 and firing at temperatures from 1200 to 1600 degrees Centigrade, preferably at temperatures from 1300 to 1500 degrees Centigrade under vacuum. Preferably, the vacuum is from 10⁻⁵ to 10⁻⁷ Torr. Spherical silicon nanospheres having an average diameter of approximately 10 nm are preferred in the formation of this anode. This construction provides a silicon bonded structure not relying on the bonding of an organic binder, such as the crosslinked dispersant-binder 330. Instead, bonding occurs between the spherical silicon nanospheres 320, the silicon carbide, the optional graphite/graphene, and the copper foil. The porosity of the material on the copper foil will be approximately 35%. The copper foil is preferably from 10 to 20 micrometers (um) in thickness, while the bonded spherical silicon nanospheres, silicon carbide, and optional graphite/graphene on the copper foil are preferably from 10 to 50 um in thickness.

Another physical structure for the anode 300 relies on the metal conductor 310 being formed from metal particulates as opposed to a foil. Thus, titanium particulates having an average diameter from 5 um to 30 um, preferably from 8 um to 20 um, and more preferably from 8 um to 15 um may be used to form a “foil-less” electrode. The spherical silicon nanospheres 320 may be combined with the titanium particulates in 50 to 60% by volume spherical silicon nanospheres to a 25% to 30% by volume titanium particulate combination. In such a combination, air constitutes the additional volume.

The titanium may be milled to have a porosity up to approximately 70% and have a “star-like” shape. For example, the titanium may be hammer milled from titanium sponge, where the titanium sponge is an intermediate form of titanium in the process of making silicon from titanium dioxide, rutile, or ilmenites. In this way, approximately one third of the 70% porosity of the titanium stars may be filled with the spherical silicon nanospheres 320 by coating the spherical silicon nanospheres 320 on the larger titanium stars. Dispersant-binder may be added to form a thixotropic ink from the titanium stars and the spherical silicon nanospheres 320 suspended in ethanol. This material is then coated onto a separator, thus removing the need for an electrode foil in contact with the spherical silicon nanospheres 320. The separator may be a porous plastic, ceramic, combination thereof, and the like that is non-conductive. A contact tab foil may then be attached to the separator to establish electrical conductivity from the battery terminal to the electrode. In addition to the spherical silicon nanospheres 320, spherical silicon nanospheres milled with silicon carbide, as previously discussed, may be combined with the titanium to form the foil-less electrode.

While not shown in FIG. 3A nor in FIG. 3B, in addition to the anode 300, a cathode may be similarly formed by replacing the spherical silicon nanospheres 320 with a lithium metal oxide (LiMOx) during the milling process. In a lithium ion battery, useful lithium metal oxides for cathode formation include lithium cobalt oxide (LiCoO₂), often referred to as “LCO”; lithium iron phosphate (LiFePO4); lithium manganese oxide (LiMn₂O₄, Li₂MnO₃), often referred to as “LMO”; lithium nickel manganese cobalt oxide (LiNiMnCoO₂), often referred to as “NMC or NCM”; lithium nickel cobalt aluminum oxide (LiNiCoAlO₂), often referred to as NCA; and lithium titanate (Li₄Ti₅O₁₂), often referred to as “LTO”.

Presently, a preferable lithium metal oxide for cathode formation is LCO. Thus, instead of a mono silane (SiH₄) starting material having particle sizes in the sub-micron to 20 mm range, lithium metal oxide particles having particle sizes in the sub-micron to 20 mm range as previously discussed are added to the mill to form spherical metal oxide nanospheres. The spherical metal oxide nanospheres resulting from milling used for cathode formation have an average diameter from 3 to 70 nanometers (nm), preferably from 7 to 20 nm, and more preferably from 9 to 15 nm.

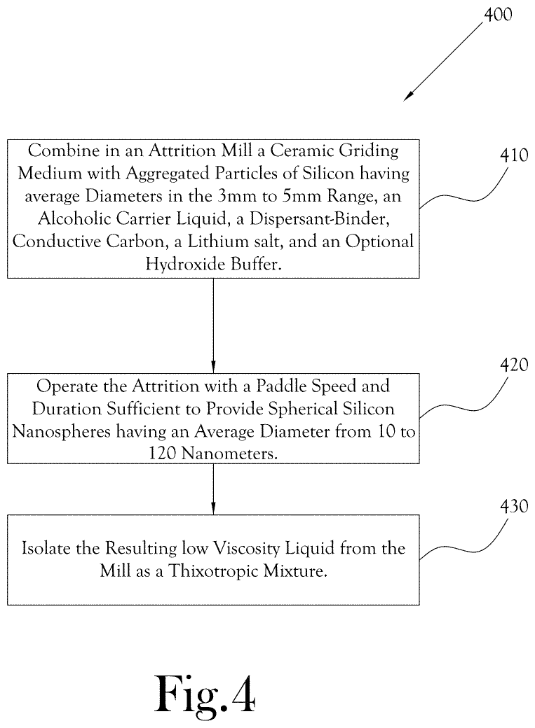

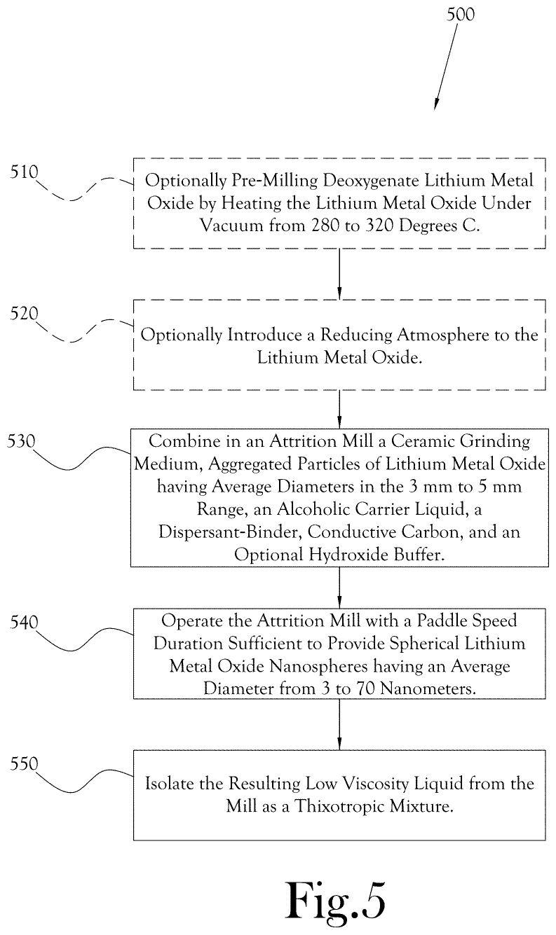

FIG. 4 represents a method 400 of forming a thixotropic mixture suitable for anode formation. In 410, a ceramic grinding medium, aggregated particles of silicon having average diameters in the 3 mm to 5 mm range, an alcoholic carrier liquid, a dispersant-binder, conductive carbon, a lithium salt, and a hydroxide buffer are combined.

The thixotropic mixture preferably is formed in a closed, high energy, and high shear mill. An attrition mill is preferred since it allows attrition with minimal atmospheric or other contamination and provides particles having a narrow particle size distribution after milling. The attrition mill preferably uses a ceramic grinding medium, more preferably a zirconium or alumina or silicon nitride grinding medium. The silicon used as the starting material to form the spherical silicon nanospheres is preferably obtained from a fluidized bed reactor process in the form of aggregated particles of mono silane (SiH₄) having average diameters in the sub-micron to 20 mm range, preferably in the 1 micron to 8 mm range, and more preferably in the 3 mm to 5 mm range. These aggregated particles in addition to other desired constituents are then milled in the attrition mill under the alcoholic carrier liquid to exclude oxygen and other contaminants from the milling process. The dispersant-binder, conductive carbon, optional lithium salt, and optional buffer may be combined with the silicon and alcoholic carrier liquid at various times during the milling process to achieve the desired thixotropic mixture.

As the milling process reduces the average diameter of the silicon particles, the total exposed surface area of silicon metal increases. If present during milling, the binder thus is adsorbed in increasing amounts onto the growing surface area of silicon newly exposed by the milling process, thus reducing the binder content in the alcoholic carrier liquid. The process also decreases the resting viscosity and shear viscosity of the resultant thixotropic mixture, and additional dispersant-binder may be added to increase the solution concentration of the dispersant-binder.

The conductive carbon and optional lithium salt may be added before, during, or after milling the silicon metal particles. Preferably, the conductive carbon is added towards the end of the milling process when the desired particle size and particle size distribution of the silicon now coated with binder is realized. Such latter conductive carbon addition provides the benefit of newly exposed silicon metal surfaces for adherence of the conductive carbon. Addition of the optional lithium salt also is preferred toward the end of the milling process.

In 420, the attrition mill is operated with a paddle speed duration sufficient to provide spherical silicon nanospheres having an average diameter from 3 to 70 nanometers. The attrition mill preferably is operated to provide a water-like consistency to the slurry at a temperature near or below room temperature. Suitable milling grinding speeds can range from 200 to 600 revolutions per minute (RPM). The preferred slurry temperature may be achieved by a cooling jacket on the outer diameter of the attrition mill through which a cooling fluid is circulated. Cooling during milling provides a reduction in oxidation of the materials in the mill and maintains a temperature low enough to avoid the explosive potential of very fine silicon exposed to oxygen and heat. Despite the large amount of energy introduced into the mill contents by the rapidly rotating paddles, the contents of the mill are cooled by the liquid circulating in the cooling jacket.

In 430, the resulting low viscosity liquid is isolated from the mill as a thixotropic mixture. The thixotropic mixture may then be applied to the metal conductor using an application method that applies a shear force to the thixotropic mixture to reduce the viscosity of the mixture. Preferably, the thixotropic mixture spread on the surface of the metal conductor is from 10 to 500 micrometers, with thicknesses from 60 to 100 micrometers being more preferred; however, other thicknesses may be used depending on the intended use of the formed electrode.

While any application method that applies the desired shear force to the thixotropic mixture during application to the metal conductor may be used, a spiral film applicator or doctor blade method is preferred, with the doctor blade method being more preferred. A preferred application method involves a high-speed roll-to-roll operation where a metal foil is passed under a dispenser and the thixotropic mixture is applied to one or both sides of the metal foil. Thus, the ability to reproducibly form the desired film thickness is enhanced as the thixotropic mixture thins during application to the surface of the metal conductor, and then thickens to hold a physical shape after removal of the applied shear force that spreads the mixture on the surface of the metal conductor.

After spreading the thixotropic mixture on the surface of the metal conductor, the mixture is cured to form the electrode. The cured thixotropic mixture preferably constitutes from 1% to 5% by weight of the metal conductor (weight cured thixotropic mixture/weight of metal conductor). The metal conductor including the cured thixotropic mixture may then be formed or punched into shapes suitable for cylindrical or pouch-type battery formation.

Curing includes crosslinking the polymeric dispersant-binder to physically bond the spherical silicon nanospheres and other materials to the surface of the metal conductor. The crosslinked dispersant-binder also provides physical support to the solid constituents of the thixotropic mixture on the metal conductor after removal of the alcoholic carrier liquid.

Curing may be implemented through heating, ultraviolet (UV) light, and other crosslinking techniques. For example, a heat dryer or UV light may be used to evaporate the alcoholic carrier liquid and heat crosslink the dispersant-binder on the metal foil. In the instance of heat, a temperature of approximately 300 degrees Centigrade under an oxygen excluding, reducing atmosphere, as will be discussed further below, is preferred. Crosslinking techniques also may be combined. For example, heating may be used to primarily remove the alcoholic carrier liquid, while UV light performs the majority of the crosslinking of the dispersant-binder on the metal conductor.

FIG. 5 represents a method 500 of forming a thixotropic mixture suitable for cathode formation. To form a thixotropic mixture suitable for cathode formation, in addition to milling the lithium metal oxide as previously discussed for silicon to exclude oxygen contamination, the lithium metal oxide may be deoxygenated before milling. In 510, optional pre-milling deoxygenation may be performed by heating the lithium metal oxide under vacuum from 280 to 320 degrees C., preferably from 295 to 305 degrees C. Preferable vacuums are from 10⁻³ to 10⁻⁷ Torr. In 520, deoxygenation may be continued through the optional introduction of a reducing atmosphere that may reduce the water, oxygen, and hydroxide content of the lithium metal oxide to below 3% by weight, preferably to below 2% by weight, and more preferably to below 1% by weight (weight water, oxygen, and hydroxide/weight lithium metal oxide).

In 530, a ceramic grinding medium, aggregated particles of lithium metal oxide having average diameters in the 3 mm to 5 mm range, an alcoholic carrier liquid, a dispersant-binder, conductive carbon, and an optional hydroxide buffer are combined. In 540, the attrition mill is operated with a paddle speed duration sufficient to provide spherical lithium metal oxide nanospheres having an average diameter from 3 to 70 nanometers. In 550, the resulting low viscosity liquid is isolated from the mill as a thixotropic mixture.

By milling the lithium metal oxide in the alcoholic carrier liquid under the inert atmosphere, as previously discussed with regard to silicon, lithium metal oxides may be formed that include less than 15% by weight, preferably less than 10% by weight, and more preferably less than 5% by weight undesirable oxides of lithium, including Li₂O, Li₂CO₃, and LiOH. By also deoxygenating before milling the lithium metal oxide, the undesirable oxides of lithium may be reduced to less than 3% by weight, more preferably less than 1% by weight. In combination, the pre-milling deoxygenation and alcoholic carrier liquid milling can reduce undesirable lithium oxides at the cathode by up to three orders of magnitude in relation to conventional cathodes. By reducing undesirable oxide formation in the cathode material before the cathode is formed, the life of the battery may be extended.

While not wishing to be bound by any particular theory, it is believed that the fewer undesirable oxides of lithium introduced to the battery by reactive oxygen contaminants at the cathode, the less electrolyte constituents will be deactivated. For example, electrolyte constituents, such as disulfonylimide salts and fluoroethylene carbonate additives, may be oxidatively deactivated through conversion of an electrolyte salt, such as LiPF₆, to LiF and PFs, which may then be hydrolyzed to HF and PF₃O, respectively.

An extension in battery life should result not only from a reduction in electrolyte oxidative deactivation, but also from a reduction in the formation of chemical species, such as HF, which may attack and corrode the electrodes of the battery. This electrochemical degradation of the electrolyte constituents coupled with thermal energy generated during operation of the battery is believed to be a significant contributor to battery failure.

As previously described with regard to anode formation, the dispersant-binder, alcoholic carrier liquid, conductive carbon, and optional constituents, such as buffers, may be combined with the metal oxide nanospheres to obtain the desired thixotropic mixture for cathode formation. This thixotropic mixture may be applied to an aluminum metal substrate, such as aluminum foil, to form a metal foil-based electrode. As also previously described regarding anode formation, alternatively, the metal oxide nanospheres may be combined with titanium particulates, with or without binder, to eliminate the use of the metal foil to form the cathode.

The anode and cathode are placed on either side of a separator in a battery casing and electrolyte added to form a battery. While the electrolyte may be liquid, solid electrolyte forms are preferred.

The described anodes when used in a lithium ion battery may provide an order of magnitude or greater increase in current capacity in relation to conventional carbon-based anodes, eliminate cycling based anode failure, provide faster charge and discharge cycles, provide a lighter weight per unit performance, and an increased charge capacity. The described spherical silicon nanospheres may allow the charge and discharge rate of the battery to be higher than for non-spherical and larger silicon particles. The contact resistance problem conventionally believed to result from tiny spherical silicon nanospheres is addressed by milling the silicon under the alcoholic carrier in the presence of the dispersant-binder at a temperature near or less than room temperature while substantially excluding oxygen.

The described cathodes when used in a lithium ion battery may provide an order of magnitude or greater increase in the number of discharge and recharge cycles the battery may sustain before losing sufficient energy output or conductivity to maintain usefulness. The combination of the described significantly reduced oxygen content cathodes and the described anodes provide a battery with increased electrical output and longevity.

The described silicon-based anodes are more susceptible to failure from oxidation and oxidation products of the electrolyte arising from oxide contaminated cathodes than conventional carbon-based anodes having graphene X-Y plane layers that are less susceptible to oxidation. Preferably, from 4,000 to 10,000 charge/discharge cycles are provided by the combination of the described silicon-based anodes and deoxygenated cathodes.

The following examples are provided to illustrate one or more preferred embodiments of the invention. Numerous variations can be made to the following examples that lie within the scope of the invention.

### EXAMPLES

### Example 1: Preparation of Thixotropic Mixture

Fluidized bed silicon of eight nines purity made from mono silane (SiH₄) as an aggregate of 10-20 nm spheres with a D50 of 4 microns was combined in a Union Process 1s batch attrition mill (available from Union Process, Inc., Akron, Ohio) with 800 nm zirconia media. Approximately 800 grams of silicon were combined with approximately 1.2 liters of ethanol and approximately 13.6 kg of media. Polyacrylic acid was added to the mill at approximately 0.25% by weight in relation to the silicon.

Carbon black was added from 1% to 5% and lithium hydroxide was added from 3% to 5% by weight in relation to the silicon towards the end of the run. Sodium hydroxide was added to provide a neutral or nearly neutral pH. The mill was operated with a paddle speed of approximately 400 revolutions per minute (RPM) at a temperature of approximately 20° C. for approximately six hours to obtain a water-like viscosity for the thixotropic mixture.

### Example 2: Prophetic Preparation of an Anode

The thixotropic mixture prepared in Example 1 may be emptied from the mill and applied to a copper metal foil. The mixture is allowed to rest to undergo a viscosity increase before being applied to the copper foil with a doctor blade. The mixture may then be dried and crosslinked onto the foil with heat and/or a combination of heat and UV light to obtain an anode. Anodes made in this way are expected to have solids loading in the 65% range with current capacities up to 2,730 mAh/gram.

### Example 3: Prophetic Preparation of a LCO Cathode

A thixotropic mixture prepared in accord with Example 1, but where the mono silane is substituted with lithium cobalt oxide may be emptied from the mill and applied to an aluminum metal foil. The mixture is allowed to rest to undergo a viscosity increase before being applied to the aluminum foil with a doctor blade. The mixture may then be dried and crosslinked onto the foil with heat and/or a combination of heat and UV light to obtain a cathode.

### Example 4: Prophetic Preparation of a NMC Cathode

A thixotropic mixture prepared in accord with Example 1, but where the mono silane is substituted with NMC having average particle diameters in the 3- to 20-micron size range. In addition to the NMC being milled, carbon black is milled to achieve a stable viscosity before addition of the NMC to the mill. The Polyacrylic acid may be replaced with a mixture of polyvinylidene fluoride (PVDF) and N-methyl-2-pyrrolidone (NMP), which is added to the mill once the NMC has reached the desired average particle diameter or added to the slurry emptied from the mill. The resulting thixotropic mixture may be applied to an aluminum metal foil. The mixture is allowed to rest to undergo a viscosity increase before being applied to the aluminum foil with a doctor blade. The mixture may then be dried and crosslinked onto the foil with heat and/or a combination of heat and UV light to obtain a cathode.

### Example 5: Prophetic Preparation of a Deoxygenated Cathode

The cathode of Example 3 or Example 4 may be prepared by adding a deoxygenation step before milling. The lithium metal oxide is heated to 280 to 320 degrees C. under approximately 10⁻⁴ Torr. When this temperature is reached, a reducing atmosphere of argon with approximately 5% hydrogen is introduced for approximately 2 to 20 minutes. When cooled, the deoxygenated lithium metal oxide is introduced to the mill and alcoholic carrier liquid under inert atmosphere and milling is initiated as previously described.

### Example 6: Charge and Discharge Performance

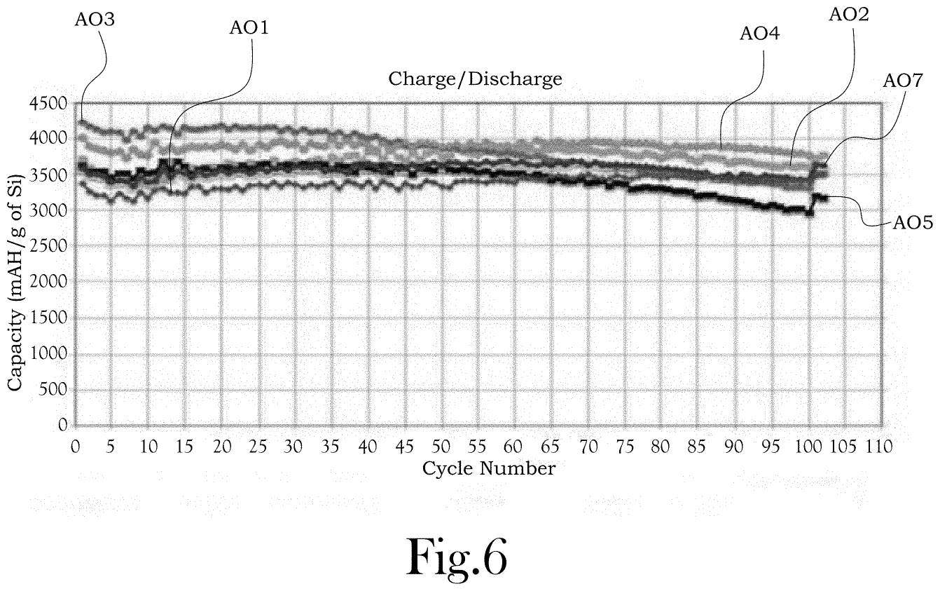

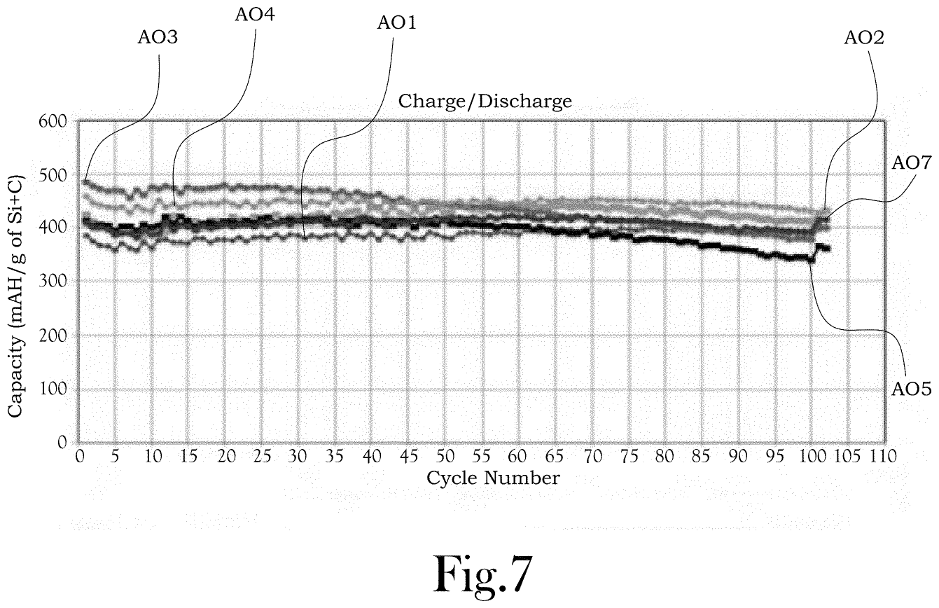

FIG. 6 is a graph of the charge/discharge performance of six half cells (AO1, AO2, AO3, AO4, AO5, and AO7) formed from a thixotropic mixture including spherical silicon nanospheres (8%), SUPER P conductive carbon (62%), and PPA dispersant-binder (30%) dry weight component/dry weight total. The Y-axis provides the capacity in mAh per gram of silicon, while the X-axis provides the cycle. FIG. 7 represents that same data where the Y-axis provides the capacity in mAh per gram of silicon+carbon. As established in the graphs, little performance degradation was observed after 110 charge/discharge cycles.

To provide a clear and more consistent understanding of the specification and claims of this application, the following definitions are provided.

Silicon metal is in elemental form, thus not in the form of an oxide or ionic salt. In this application, “silicon” and “silicon metal” are used interchangeably unless the specific context establishes otherwise, such as when mono-silane (SiH₄) is being addressed.

Thixotropic means a mixture that undergoes a reduction in viscosity when a shearing force is applied. Thixotropic mixtures may take on a shape independent of their container when at rest, but become liquid when a shearing stress is applied.

An alcoholic carrier liquid is an alcoholic liquid that solubilizes any dispersant-binders, suspends the silicon metal during milling, and reduces exposure of the exposed silicon metal surfaces to oxygen and other contaminants during processing and milling. During milling, fresh silicon metal surfaces are exposed that would be exposed to the atmosphere without the alcoholic carrier liquid. Alcoholic carrier liquids include ethanol, 1,2-propendiol, acetone, and the like. Other alcoholic carrier liquids may be used that form an azeotrope with water where the last few percent of water cannot be distilled from the alcohol. During processing and milling, the alcoholic carrier is substantially maintained at a water content where it traps and holds the water as opposed to being saturated to the point water is released. For example, ethanol will uptake water at concentrations up to about 5% by weight, while at higher water concentrations, the ethanol will release the water.

A dispersant-binder is molecule having both hydrophilic and hydrophobic properties that is soluble in alcoholic carrier liquids. For example, the dispersant-binder polyacrylic acid has a hydrophobic backbone (essentially polyethylene) with one hydrophilic carboxyl group at every other carbon along the backbone. The carboxyl group includes two oxygen atoms, making the PAA soluble in alcoholic carrier liquids, such as ethanol. The hydrophobic backbone may be attracted to a silicon surface, while the hydrophilic carboxyl groups are attracted to the alcoholic carrier liquid—thus performing as a dispersant through steric hindrance.

Elastic dispersant-binders have elastomeric limits of at least 300% by volume.

Reducing atmospheres include a mixture of argon and hydrogen, forming gas (nitrogen and hydrogen), and the like. A preferred reducing atmosphere is a mixture of argon and hydrogen where hydrogen makes up from 5% to 10% (weight hydrogen/weight argon) of the mixture.

The term “on” is defined as “above” and is relative to the orientation being described. For example, if a first element is deposited over at least a portion of a second element, the first element is said to be “deposited on” the second. In another example, if a first element is present above at least a portion of a second element, the first element is said to be “on” the second. The use of the term “on” does not exclude the presence of substances between the upper and lower elements being described. For example, a first element may have a coating over its top surface, yet a second element over at least a portion of the first element and its top coating can be described as “on” the first element. Thus, the use of the term “on” may or may not mean that the two elements being related are in physical contact with each other.

Note that spatially relative terms, such as “up,” “down,” “right,” “left,” “beneath,” “below,” “lower,” “above,” “upper” and the like, may be used for ease of description to describe one element or feature's relationship to another element or feature. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

While various embodiments of the invention are described, it will be apparent to those of ordinary skill in the art that other embodiments and implementations are possible within the scope of the invention. Accordingly, the invention is not to be restricted except in light of the attached claims and their equivalents.

1. A thixotropic liquid mixture for forming a lithium ion battery anode electrode, the liquid mixture comprising:
a solid mixture in an alcoholic carrier liquid, the solid mixture comprising:
spherical silicon nanospheres having an average diameter from 10 to 120 nanometers and comprising from 20% to 25% of the solid mixture by weight;
conductive carbon comprising from 60% to 75% of the solid mixture by weight; and
a dispersant-binder comprising from 3% to 20% of the thixotropic mixture by weight.

2. The thixotropic liquid mixture of claim 1, further comprising a lithium salt constituting from 1% to 5% of the thixotropic liquid mixture by weight.

3. The thixotropic liquid mixture of claim 1, further comprising a buffer constituting from 3% to 5% of the thixotropic liquid mixture by weight.

4. The thixotropic liquid mixture of claim 1, where the dispersant-binder is an elastic dispersant binder.

5. The thixotropic liquid mixture of claim 4, where the elastic dispersant-binder is selected from the group consisting of polycaprolactone copolyester-type thermoplastic polyurethanes, polyester-type TPUs, polyether-type TPUs, diblock copolymers of styrene and butadiene, cellulose acetate butyrates, ethylene-vinyl acetate copolymers, and combinations thereof.

6. The thixotropic liquid mixture of claim 4, where the elastic dispersant-binder is a polyester-type TPU.

7. The thixotropic liquid mixture of claim 1, where the alcoholic carrier liquid is selected from the group consisting of ethanol, 1,2-propendiol, and combinations thereof.

8. The thixotropic liquid mixture of claim 1, where the alcoholic carrier liquid is ethanol.

9. The thixotropic liquid mixture of claim 1, where the conductive carbon is carbon black.

10. The thixotropic liquid mixture of claim 2, where the lithium salt is lithium hydroxide.

11. The thixotropic liquid mixture of claim 3, where the buffer is sodium hydroxide.

12. A method of making a thixotropic mixture for forming a lithium ion battery anode, the method comprising:
combining in an attrition mill including a ceramic grinding medium aggregated particles of silicon having average diameters in the 3 mm to 5 mm range, an alcoholic carrier liquid, an elastic dispersant-binder, conductive carbon, a lithium salt, and a hydroxide buffer;
operating the attrition with a paddle speed and duration sufficient to provide spherical silicon nanospheres having an average diameter from 10 to 120 nanometers;
isolating the resulting low viscosity liquid from the mill as a thixotropic mixture.

13. The method of claim 12, where the paddle speed of the mill is approximately 400 revolutions per minute.

14. The method of claim 12, where the spherical silicon nanospheres have an average diameter from 20 to 30 nanometers.

15. The method of claim 12, where the ceramic grinding medium is a zirconium grinding medium.

16. An anode electrode for a lithium battery, the electrode comprising:
a metal conductor; and
a crosslinked polymer matrix on the metal conductor, the crosslinked polymer matrix including
spherical silicon nanospheres having an average diameter from 10 to 70 nanometers,
a crosslinked elastic dispersant-binder,
conductive carbon on the spherical silicon nanospheres,
a lithium salt, and
a hydroxide buffer.

17. The electrode of claim 16, where the metal is conductor is copper foil.

18. The electrode of claim 16, where the spherical silicon nanospheres have an average diameter from 20 to 30 nanometers.

19. The electrode of claim 16, where the crosslinked elastic dispersant binder is selected from the group consisting of crosslinked polycaprolactone copolyester-type thermoplastic polyurethanes, crosslinked polyester-type TPUs, crosslinked polyether-type TPUs, crosslinked diblock copolymers of styrene and butadiene, crosslinked cellulose acetate butyrates, crosslinked ethylene-vinyl acetate copolymers, and combinations thereof.

20. The electrode of claim 16, where the conductive carbon is carbon black.

21. The electrode of claim 16, where the buffer is sodium hydroxide.

22. The electrode of claim 16, where the crosslinked polymer matrix comprises from 1% to 5% by weight of the electrode.

23. The electrode of claim 16, where the crosslinked polymer matrix on the metal conductor has a thickness of from 10 to 500 micrometers on the metal conductor.

24. A thixotropic mixture for forming a lithium ion battery cathode electrode, the mixture comprising:
spherical lithium cobalt oxide nanospheres having an average diameter from 3 to 70 nanometers;
a dispersant-binder constituting from 0.25% to 5% of the thixotropic mixture by weight;
an alcoholic carrier liquid; and
conductive carbon constituting from 1% to 5% of the thixotropic mixture by weight.

25.-32. (canceled)

33. A method of making a thixotropic mixture for forming a lithium ion battery cathode electrode, the method comprising:
combining in an attrition mill including a ceramic grinding medium aggregated particles of lithium cobalt oxide having average diameters in the 3 mm to 5 mm range, an alcoholic carrier liquid, a dispersant-binder, conductive carbon, and a hydroxide buffer;
operating the attrition with a paddle speed and duration sufficient to provide spherical lithium cobalt oxide nanospheres having an average diameter from 3 to 70 nanometers;
isolating the resulting low viscosity liquid from the mill as a thixotropic mixture.

34.-36. (canceled)

37. A cathode electrode for a lithium battery, the electrode comprising:
a metal conductor; and
a crosslinked polymer matrix on the metal conductor, the crosslinked polymer matrix including
spherical lithium cobalt oxide nanospheres having an average diameter from 3 to 70 nanometers,
a crosslinked dispersant-binder,
conductive carbon on the spherical lithium cobalt oxide nanospheres, and
a hydroxide buffer.

38.-44. (canceled)

45. An anode electrode for a lithium battery, the electrode comprising:
a copper foil; and
bonded spherical silicon nanospheres having average diameters from 10 to 70 nanometers on the copper foil,
a lithium salt, and
a hydroxide buffer.

46.-52. (canceled)

53. An anode electrode for a lithium battery, the electrode comprising:
spherical silicon nanospheres having average diameters from 10 to 70 nm bonded on titanium particulates having up to 70% porosity and an average diameter from 5 to 30 micrometers,
a crosslinked elastic dispersant-binder adhering the titanium particulates and spherical silicon nanospheres to a separator; and
a lithium salt.

54.-56. (canceled)
